(19) United States
(12) Patent Application Publication
(10) Pub. No.: US 2012/0128916 A1
(43) Pub. Date: May 24, 2012

(54) MOLDED OBJECT, METHOD OF PRODUCING THE SAME, SEALED MOLDED OBJECT, POLYMER, AND OPTICAL INFORMATION RECORDING MEDIUM

(75) Inventor: Noriyuki Saito, Miyagi (JP)

(73) Assignee: Sony Corporation, Tokyo (JP)

(21) Appl. No.: 13/288,362

(22) Filed: Nov. 3, 2011

(30) Foreign Application Priority Data
Nov. 18, 2010 (JP) 2010-258081

(51) Int. Cl. B32B 3/02; B29C 35/02; B29C 47/00; C08G 77/14

(52) U.S. Cl. 428/64.4; 528/26; 264/299; 264/211.24

(57) ABSTRACT

There are provided a molded object, a method of producing the same, a sealed molded object, a polymer, and an optical information recording medium, in each of which curing may be achieved at around room temperature in a short time without addition of an accelerator, and volumetric shrinkage accompanying the curing may be suppressed. The molded object is obtained by curing a curable composition containing a silicon analogue having one or more epoxy groups and an α-hydroxy acid.

### BACKGROUND

The present disclosure relates to a molded object, a method of producing the molded object, a sealed molded object, a polymer, and an optical information recording medium. Specifically, the present disclosure relates to a molded object obtained by curing a silicon analogue having an epoxy group.

When a silicon analogue having an epoxy group is cured, a compound having an amino group, a thiol group, an acid anhydride group, a hydroxy group, and the like is mixed therewith as a curing agent. However, in many cases, the progress of a reaction is slow by merely mixing these ingredients and thus, addition of an accelerator to promote a curing reaction catalytically is desired. As the accelerator, there are known organic amine compounds, organophosphorus compounds, borate esters, Lewis acids, organometallic compounds, organic acid metal salts, and the like are known (for example, See Japanese Unexamined Patent Application Publications No. 2001-122947 and No. 2008-163311). Organic solvents are usually used to dissolve these ingredients or to increase compatibility.

When a curable composition is cured, the curing is often accompanied by volatilization of an organic solvent, volumetric shrinkage or irregular deformation, occurrence of a crack, and the like. Therefore, in order to obtain a molded article of target dimensions without using a filler material such as fillers, there is employed a method of determining a shrinkage factor beforehand, and performing molding with a size to which an amount of shrinkage is added. Alternatively, there is employed a method of making a molded article slightly larger than target dimensions, and performing a dimensional adjustment by cutting. A dimensional shrinkage factor in room temperature curing is said to be around 0.1 to 0.2% for silicone resin, 0.3% for epoxy resin, 0.3 to 0.5% for urethane resin, 7 to 10% for polyester resin or acrylic resin.

### SUMMARY

When it is attempted to fill an enclosed molding device with a curable composition and cure the curable composition, volumetric shrinkage of a resin and generation of a volatile matter accompanying the curing may occur, which is not desirable.

For example, it is known that acrylic materials have relatively large volumetric shrinkage accompanying curing, and separation of a resin from a molding device may occur during the curing, and besides this, when the molding device is also made of a resin, deformation of the molding device itself may be caused.

A material having an epoxy group or an oxetane group as a linking group has a relatively small volumetric change, but usually, addition of an accelerator is desired. The accelerator when used alone does not easily dissolve in a curable composition in many cases, and usually, a method of dissolving the accelerator in an organic solvent and combining them with the curable composition is employed. Therefore, when the curable composition is filled into an enclosed molding device and cured, the organic solvent remains in a system, and a disadvantage such as generation of air bubbles or seepage after the curing may be brought about. In addition, these accelerators and organic solvents are harmful substances or hazardous materials in many cases and thus may become a cause of environmental pollution. Moreover, when these accelerators and organic solvents are used in daily necessities which may directly touch human bodies, there is a fear of adversely affecting the health. Further, there are many accelerators having an ultraviolet absorption effect or an oxidized effect, and a wavelength modification of a transmitted beam such as yellowing of a molded object (polymer) easily occurs.

In view of the foregoing, it is desirable to provide a molded object, a method of producing the same, a sealed molded object, a polymer, and an optical information recording medium, in each of which curing may be achieved at around room temperature in a short time without addition of an accelerator, and volumetric shrinkage accompanying the curing may be suppressed.

According to an embodiment of the present disclosure, there is provided a molded object obtained by curing a curable composition containing a silicon analogue having one or more epoxy groups and an α-hydroxy acid.

According to another embodiment of the present disclosure, there is provided a sealed molded object including, a molding device having a molding space inside, and a molded object molded in the molding space, in which the molded object is obtained by curing a curable composition containing a silicon analogue having one or more epoxy groups and an α-hydroxy acid.

According to another embodiment of the present disclosure, there is provided a method of producing a molded object, the method including preparing a curable composition containing a silicon analogue having one or more epoxy groups and an α-hydroxy acid, and forming a molded object by curing the curable composition.

According to another embodiment of the present disclosure, there is provided a polymer obtained by polymerizing a silicon analogue having one or more epoxy groups, by using a proton originating from an α-hydroxy acid as an initiator.

According to another embodiment of the present disclosure, there is provided an optical information recording medium including a recording layer, and a recording-layer molding device inside which the recording layer is molded, in which the recording layer is obtained by curing a recording-layer forming composition, and the recording-layer forming composition contains a silicon analogue having one or more epoxy groups, an α-hydroxy acid, and a foam material.

In the present disclosure, sealing includes not only a state where the molded object is completely isolated by the molding device from the air, but also a state where the molded object is partially exposed from the molding device to the air. For example, when the molding device has an opening section in an internal space to injection and discharge the curable composition, a state in which the molded object is exposed to the air through this opening section is also included.

The molded object is an example of the polymer, and is molded by a predetermined mold such as a die and a molding device. The polymer includes not only an object molded with a predetermined mold or the like, but also a bulk body, a thin film, or the like having an optional shape and formed without using such a mold, and further includes an amorphous cured object.

In the present disclosure, it is possible to make the molded object or the polymer by preparing the curable composition through combination of the silicon analogue having the epoxy group and the α-hydroxy acid, and curing the curable composition at around room temperature within a short time, without adding an accelerator. In this curable composition, an organic solvent to dissolve ingredients may not be used and thus, there is no influence of the organic solvent upon the environment and human bodies. In addition, the ingredients of the curable composition are cured and incorporated in the structure of the cured object, and do not remain as a liquid, and moreover, there is provided such a structure that silicone is linked by the epoxy group and therefore, a volumetric change accompanying the curing is small. Therefore, even when the curable composition is filled into an enclosed molding device and cured, it is hard to cause damage or deformation of the molding device due to a volumetric change, or separation of the molded object from the molding device, and besides, it is possible to suppress generation of air bubbles from the curable composition, and seepage of the ingredient. Utilizing such a property, it is possible to realize excellent integration of the enclosed molding device and the molded object, and obtain the molded object with high dimensional accuracy. In particular, when the curable composition has transparency, by supplying the curable composition to a transparent enclosed molding device and curing the curable composition, it is possible to produce a sealed molded object which is transparent as a whole including the molding device, with high dimensional accuracy.

As described above, according to the present disclosure, it is possible to obtain a molded object at a lower temperature in a short time, without using an organic solvent and an accelerator generally known. In addition, even when the curable composition is filled into an enclosed molding device and cured, it is hard to cause separation between the molded object and the molding device and deformation of the molding device, and besides, generation of air bubbles by a volatile component and seepage of a liquid component do not easily occur. Therefore, it is possible to obtain the molded object with high dimensional accuracy, and the sealed molded object in which the molded object and the molding device are integrated.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a cross-section diagram illustrating a configurational example of an optical information recording medium according to a second embodiment of the present disclosure.

FIG. 2A is a cross-sectional diagram illustrating a configurational example of a recording-layer molding device of the optical information recording medium according to the second embodiment of the present disclosure. FIG. 2B is a plan view illustrating a configurational example of the recording-layer molding device of the optical information recording medium according to the second embodiment of the present disclosure.

### DETAILED DESCRIPTION OF EMBODIMENTS

Embodiments of the present disclosure will be described below in the following order with reference to the drawings.
1. First Embodiment (an example of a molded object and a method of producing the same)
2. Second Embodiment (an example of an optical information recording medium and a method of producing the same)

### 1. First Embodiment

### (Molded Object)

A molded object is obtained by curing a curable composition containing a silicon analogue having one or more epoxy groups and an α-hydroxy acid. Specifically, the molded object is a polymer obtained by polymerization of a silicon analogue having one or more epoxy groups, using a proton originating from the α-hydroxy acid as an initiator. The polymerization is ring-opening polymerization in which the epoxy group of the silicon analogue is ring-opened and polymerized. It is preferable that the curable composition be a thermosetting composition to be cured by a thermal reaction. Here, the thermal reaction also includes a reaction to progress spontaneously in an environment at a temperature in the neighborhood of room temperature. The neighborhood of the room temperature means a temperature range of 10° C. or more to 40° C. or less.

Further, a curable composition may be filled into a molding device and cured, and thereby used as a sealed molded object. Specifically, the sealed molded object includes a molding device having a molding space inside, and a molded object molded in the molding space of this molding device, and the molded object is obtained by curing the above-described curable composition.

The molded object is, for example, vitreous or an elastic gel. The property of the molded object such as vitreous and elastic gel may be selected by adjusting the composition of the curable composition. It is desirable that the molded object have transparency for light of a wavelength within a range of 400 nm or more to 800 nm or less, and a difference ΔTr (=Trₘₐₓ−Trₘᵢₙ) between a maximum value Trₘₐₓ and a minimum value Trₘᵢₙ of light transmittance in this wavelength range be 3% or less. This is because having such an optical property enables the molded object to be used as a raw material of a member desired to have transparency, such as optical components, optical information recording media, overcoat materials, and the like.

### (Use of Molded Object)

This molded object or the sealed molded object is not limited to a particular use, but may be applied to, for example, an optical component, an optical information recording medium, an electronic component, and the like. For example, the molded object may be used as a recording layer of an optical information recording medium, by further incorporating a vaporized material that foams in response to irradiation of a recording light beam into the curable composition. In this case, for example, the recording layer may record information signals by forming record marks made of air bubbles according to the recording light beam. The optical information recording medium may have a board or a protective layer protecting the recording layer on both sides or one side of the recording layer. As a configuration of this optical information recording medium, for example, a configuration described in Japanese Unexamined Patent Application Publication No. 2009-140528 may be used.

### (Method of Identifying Ingredient)

It is possible to identify the ingredients of the curable composition used to form the molded object or the polymer by a simple analysis. First, the molded object or the polymer is crushed, and dipped into a suitable organic solvent to cause elution of the ingredients. Subsequently, this is subjected to vacuum concentration and then, the ingredients are isolated with a chromatograph as necessary, and structure assignment is performed with H-NMR (Nuclear Magnetic Resonance), and therefore the type of the curing agent may be identified. As for the silicon analogue, similarly, an unreacting monomer or oligomer is isolated, and structure assignment is performed with H-NMR and Si-NMR.

(Silicon Analogue with Epoxy Group)

The silicon analogue having one or more epoxy groups is, for example, one or more kinds of a siloxane compound having one or more epoxy groups and an alkoxysilane compound having one or more epoxy groups, and preferably made of these two kinds of silicon analogue. This is because being made of these two kinds of silicon analogue makes it possible to suppress the occurrence of a crack at the time of curing the curable composition, and obtain high hardness. In addition, it is possible to control the hardness of the molded object over a wide range, by adjusting the respective blending quantities of the siloxane compound and the alkoxysilane compound.

Preferably, the siloxane compound having one or more epoxy groups has the main skeleton based on a siloxane bond, and has a structure in which a functional group having one or more epoxy groups is introduced as a side chain and/or an end group of this main skeleton. As a siloxane compound having such a structure, it is possible to use, for example, a compound represented by the following general formula (1).

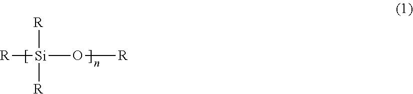

(where, in the formula, R represents an alkyl group, an aryl group, an alkyloxy group, an aryloxy group, and an ether group or a thioether group having one or more epoxy groups as a substructure, which may have a substituent and may be different from each other. One or more of them is an ether group or a thioether group having one or more epoxy groups. Preferably, R represents an alkyl group, an aryl group, an alkyloxy group, an aryloxy group, and an ether group having one or more epoxy groups as a substructure, which may have a substituent and may be different from each other. One or more of them is an ether group having one or more epoxy groups. n represents an integer of 1 or more).

It is desirable that the alkoxysilane compound having one or more epoxy groups have a structure in which a functional group having one or more epoxy groups is introduced into an alkoxysilane compound. As the alkoxysilane compound having such a structure, it is possible to use a compound represented by the following general formula (2).

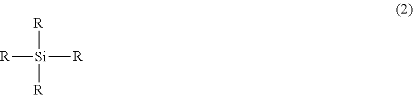

(where, in the formula, R represents an alkyl group, an aryl group, an alkyloxy group, an aryloxy group, and an ether group or a thioether group having one or more epoxy groups as a substructure, which may have a substituent and may be different from each other. One or more of them is an ether group or a thioether group having one or more epoxy groups. Preferably, R represents an alkyl group, an aryl group, an alkyloxy group, an aryloxy group, and an ether group having one or more epoxy groups as a substructure, which may have a substituent and may be different from each other. One or more of them is an ether group having one or more epoxy groups. n represents an integer of 1 or more).

### (Hydroxy Acid)

Hydroxy acid is a compound having a hydroxyl group and a carboxyl group in a molecule at the same time, and is also called hydroxy carboxylic acid, oxyacid, and alcohol acid. Aliphatic hydroxy acids may include, for example, glycolic acid, lactic acid, tartronic acid, glyceric acid, 2-hydroxybutyric acid, 3-hydroxybutyric acid, y-hydroxybutyric acid, malic acid, tartaric acid, citramalic acid, citric acid, isocitric acid, leucine acid, mevalonic acid, pantoic acid, ricinoleic acid, ricinelaidic acid, cerebronic acid, quinic acid, shikimic acid, and the like. Aromatic hydroxy acids may include, for example, salicylic acid, homosalicylic acid, hydroxy(methyl)benzoic acid, vanillic acid, syringic acid, pyrocatechuic acid, resorcyclic acid, protocatechuic acid, gentisic acid, orsellinic acid, gallic acid, mandelic acid, benzilic acid, atrolactic acid, melilotic acid, phloretic acid, coumaric acid, umbellic acid, caffeic acid, ferulic acid, sinapic acid, and the like.

Of these, it is preferable to use an α-hydroxy acid in which a hydroxyl group and a carboxyl group are connected to the same carbon atom. This is because the α-hydroxy acid is highly reactive. It is assumed that such high reactivity stems from activation of the carboxyl group by an inductive effect from the hydroxyl group. Further, it is desirable that the α-hydroxy acid be a liquid at room temperature or a solid having a low melting point, in order to compatibilize the silicon analogue having epoxy group and the α-hydroxy acid without using a solvent. Specifically, it is preferable that the melting point of the α-hydroxy acid be 100° C. or less. As the α-hydroxy acid having such a melting point, there are, for example, lactic acid (melting point 17° C.), glycolic acid (melting point 70° C.), and 2-hydroxybutyric acid (melting point 44° C.). Among them, the lactic acid which is a liquid at room temperature is particularly preferable. These hydroxy acids may be used alone, or two or more kinds may be mixed together and used.

### (Additive)

The curable composition may include an additive and a property modifier as appropriate, depending on the property desired for the molded object, other than the above-described ingredients. Specific examples of the additive and the property modifier include a filler, a pigment, a coupling agent, a fire retardant, a plasticizer, an antioxidants, a parting agent, a light absorbent, a coloring matter, and the like.

### (Synthesis of Silicon Analogue Having Epoxy Group)

For example, as a synthetic method of the silicon analogue having one or more epoxy groups, it is possible to use a method of hydrolyzing a silicon analogue having a hydrolysable group, and an alcohol or a thiol having an epoxy group in a molecule. Specifically, there may be used a method of mixing one or more kinds of a siloxane compound and an alkoxysilane compound having a hydrolysable group, with an alcohol having an epoxy group, and causing an alcohol exchange reaction to evaporate an isolated low-molecular-weight alcohol, thereby introducing the alcohol having the epoxy group.

For the alcohol exchange reaction, it is possible to add a catalyst as appropriate to promote the reaction. The catalyst may be selected from among those which do not allow ring-opening of an epoxy ring, and, for example, a metal, an organic metal, a base, or the like may be used. Specifically, there may be suitably used a metal such as sodium, potassium, and zinc, an organic metal such as dibutyltin dilaurate, or a basic compound such as tetramethylammonium carbonate, carbonic acid hydrogen tetramethylammonium, tetramethylammonium silicate, sodium methoxide, and tetramethylammonium borate.

As a method of causing a dealcoholization reaction, it is possible to use, for example, currently available methods described in Japanese Unexamined Patent Application Publication No. 1987-116673, Japanese Unexamined Patent Application Publication No. 2001-122966, and the like. However, in the present disclosure, it is preferable to cause a complete structural modification of a hydrolysable group of a siloxane compound or an alkoxysilane compound having a hydrolysable group and thus, it is desirable to use an original method which will be described below.

An alcohol having an epoxy group, e.g. a glycidol, gradually polymerizes when heated, thereby having a high molecular weight, and thus is desired to be cold-stored. When causing a dealcoholization reaction of the siloxane compound or alkoxysilane compound having an alkoxy group and a glycidol, if the set temperature is high, the ratio of polymerization of glycidols increases and moreover, the epoxy group structurally modified by the dealcoholization reaction also reacts with other epoxy group easily. In order to avoid these side reactions, it is desirable to perform the reaction at a lowest possible temperature. The dealcoholization reaction is an equilibrium reaction and thus, if the produced alcohol is excluded continuously instead of lowering the temperature, the reaction may proceed quantitatively. In the present disclosure, it is preferable to use a method of causing a reaction while performing heating under reduced pressure by using an evaporator. This is because it is possible to obtain an object that has undergone a structural modification quantitatively with short-time and extremely easy operation.

(Silicon Analogue with Hydrolysable Group)

As the silicon analogue, it is possible to use, for example, one or more kinds of a siloxane compound and an alkoxysilane compound each having a siloxane bond in a main skeleton and having a hydrolysable group at a side chain and/or an end of this main skeleton. As the hydrolysable group of the siloxane compound, it is possible to use, for example, an alkoxy group. As the alkoxy group, a methoxy group, an ethoxy group, or the like may be used.

As the siloxane compound having the hydrolysable group, it is possible to use, for example, one or more kinds of siloxanes represented by a general formula (3) and a general formula (4). When a siloxane compound in the general formula (3) or the general formula (4) is used, its mean degree of polymerization (n) is preferably 12 or less, and more preferably 8 or less. This is because when the mean degree of polymerization (n) exceeds 12, it is difficult to obtain an oligomer with uniform molecular weight distribution. These siloxane compounds may have a ring structure in which long chain ends are bound together.

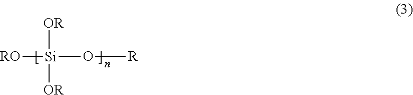

(where, in the formula, R indicates an alkyl group and an aryl group which may have a substituent and may be of two or more different kinds. n represents an integer of 1 or more).

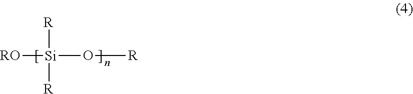

(where, in the formula, R indicates an alkyl group and an aryl group which may have a substituent and may be of two or more different kinds. n represents an integer of 1 or more.)

The siloxane compounds in the general formula (3) and the general formula (4) may include, specifically, for example, polydimethylsiloxane, polydiethylsiloxane, methyl polysilicate, ethyl polysilicate, and the like.

As the alkoxysilane compound having the hydrolysable group, it is possible to use, for example, a silicon analogue in the following general formula (5).

RₙSiOR₄₋ₙ (5)

(where, in the formula, R indicates an alkyl group and an aryl group which may have a substituent and may be of two or more different kinds. n represents an integer of 0 to 3.)

As the siloxane compound having the hydrolysable group, it is possible to directly use a commercial item represented by the general formula (3) or the general formula (4) and besides this, it is possible to obtain a siloxane compound by performing hydrolysis condensation of the alkoxysilane compound in the general formula (5). As a method of this hydrolysis condensation, it is possible to use a currently well-known method described in, for example, Japanese Unexamined Patent Application Publication No. 2009-209260.

As the alkoxysilane compound, there may be, for example, tetraalkoxysilane such as tetramethoxysilane, tetraethoxysilane, tetrapropoxysilane, tetraisopropoxysilane, and tetrabutoxysilane, trialkoxysilane such as methyltrimethoxysilane, methyltriethoxysilane, methyltripropoxysilane, methyltributoxysilane, ethyltrimethoxysilane, ethyltriethoxysilane, n-propyltrimethoxysilane, n-propyltriethoxysilane, isopropyltrimethoxysilane, isopropyltriethoxysilane, phenyltrimethoxysilane, phenyltriethoxysilane, and the like, dimethyldimethoxysilane, dimethyldiethoxysilane, diethyldimethoxysilane, diethyldiethoxysilane, diphenyldimethoxysilane, diphenyldiethoxysilane, etc.

When the hydrolysis condensation of any of these silicon analogues having a hydrolysable group is performed, by using the one represented by the general formula (5) where n=1 to 2, homopolymerization may be performed, or two or more kinds may be selected as appropriate and the compounding ratio may be adjusted to thereby cause polymerization.

### (Alcohol and Thiol Having Epoxy Group)

As the alcohol or thiol having the epoxy group, for example, an epoxy-containing alcohol such as glycidol may be used alone, and besides this, it is possible to also use, for example, what is obtained by causing a polyhydric alcohol or a mercapto alcohol to partially react with an epihalohydrin according to a usual technique to obtain ether linkage.

As the polyhydric alcohol, there may be, for example, ethyleneglycol, 1,3-propanediol, 2-methyl-1,3-propanediol, 1,2-propanediol, 1,4-butanediol, 2-methyl-1,4-butanediol, 1,3-butanediol, 1,2-butanediol, glycerol, 2,3-butanediol, and the like. As the mercaptoalcohol, there may be, for example, 2-mercaptoethanol, 3-mercapto-1-propanol, 3-mercapto-1-propanol, 2,3-dimercapto-1-propanol, 3-mercapto-1,2-propanediol, 1,3-propanedithiol, and the like.

As for the alcohol or thiol having the epoxy group of any of these, only one kind may be used, or two or more kinds may also be used at the same time.

### (Curing Reaction of Curable Composition)

The curable composition having the above-described combination is cured by performing ring-opening polymerization of the epoxy group of the silicon analogue. At the time, the α-hydroxy acid acts as a curing agent and then, links to the end of a polymer skeleton. The curing reaction of the curable composition proceeds, for example, as represented by the following reaction formula (6).

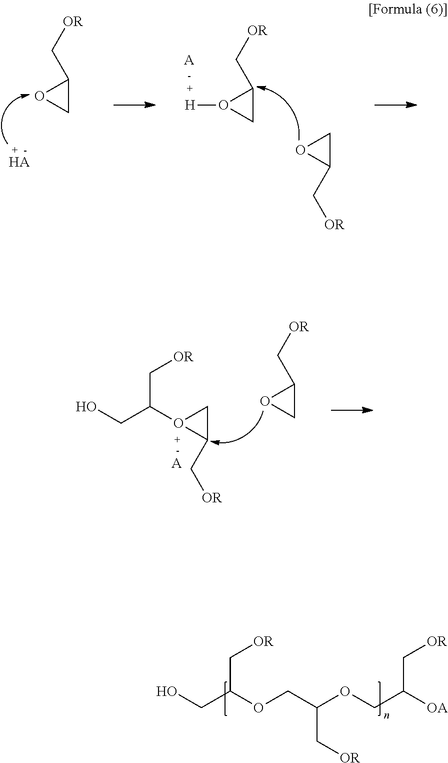

(where, in the reaction formula, R represents an alkyl group or an aryl group that may have a substituent, HA represents a protonic acid such as an α-hydroxy acid.)

When the blending quantity of the α-hydroxy acid increases, the reaction rate tends to increase, and a molded object (a polymer) tends to become vitreous in a certain range. This may be explained as follows. Theoretically, when there is one cation, a polymerization reaction proceeds limitlessly, until all epoxy groups are consumed, but actually, the reaction stops in progress because of various factors. It is conceivable that the molded object will become vitreous in a certain or higher compounding ratio, because occurrence of the polymerization becomes easier and a crosslink density increases, as the compounding ratio of the α-hydroxy acid used as a cationic source rises relative to the epoxy group.

The curable composition containing the silicon analogue having the epoxy group and the α-hydroxy acid may be produced based on blending in an optional ratio according to the properties of the molded object (polymer) and the desired hardness. In this compounding ratio, it is desirable that the ratio between the number of all the epoxy groups included in the silicon analogue having the epoxy group, and the number of all the carboxyl groups included in the α-hydroxy acid be 1/1 or higher. In other words, as represented by the reaction formula (6), the epoxy group causes a chain of polymerizations by using the proton originating from the carboxyl group as an initiator. For this reason, the curing reaction proceeds sufficiently, even when the number of epoxy groups in the silicon analogue having the epoxy group is larger than the number of carboxyl groups in the α-hydroxyl acid. Therefore, in order to obtain a molded object (polymer) with a high crosslink density, it is desirable to perform mixing so that the number of epoxy groups is larger than the number of carboxyl groups.

There is no limit in particular to the compounding ratio between the siloxane compound into which a functional group having an epoxy group is introduced and the alkoxysilane compound into which a functional group having an epoxy group is introduced, and it is possible to adjust the compounding ratio as appropriate according to the desired property. When the functional group having the epoxy group is a glycidol, a siloxane oligomer into which the glycidol is introduced has a reaction rate of a reaction with the α-hydroxy higher than that of an alkoxysilane compound into which the glycidol is introduced in many cases, and the obtained molded object (polymer) becomes vitreous easily. When the compounding ratio of the α-hydroxy acid is high, there may be brought about a disadvantage such as curing while the curable composition is mixed or occurrence of a crack due to production of heat accompanying the curing. When the alkoxysilane compound into which the glycidol is introduced is combined with the siloxane oligomer into which the glycidol is introduced, the reaction rate may be reduced, and the time before starting the curing may be increased. In addition, it is possible to control properties such as elastic modulus, crack resistance, transmitted-light wavelength, and the like, by mixing, for example, an alkoxysilane compound having a functional group that has an epoxy group and a nonresponsive functional group at the same time.

It is desirable that a ratio (α/β) of a mass a of the α-hydroxy acid to a mass β of the siloxane compound having one or more epoxy groups be 1/40 or more and 1/1 or less. When the mass ratio (α/β) is less than 1/40, a disadvantage such as taking a long time to achieve appropriate hardness for a molded object, application of heat, or the like tends to be brought about. When the mass ratio (α/β) exceeds 1/1, polymerization of epoxy groups does not readily occur, and a curable object is hard to obtain for whatever condition.

When the curable composition includes both the siloxane compound and the alkoxysilane compound having one or more epoxy groups as the silicon analogue having one or more epoxy groups, it is desirable to have the mass ratio therebetween as follows.

That is, a mass ratio (α/β1+β2)) of a mass α of the α-hydroxy acid to a siloxane compound β1 and an alkoxysilane compound β2 having one or more epoxy groups is desirably 1/40 or more and 1/1 or less. When the mass ratio (α/β) is less than 1/40, a disadvantage such as taking a long time to achieve appropriate hardness for a molded object, application of heat, or the like tends to be brought about. When the mass ratio (α/β) exceeds 1/1, polymerization of epoxy groups does not readily occur, and a curable object is hard to obtain for whatever condition. In this case, the mass ratio (β2/β1) of the alkoxysilane compound β2 having one or more epoxy groups to the siloxane compound β1 having one or more epoxy groups is preferably 1/20 or more and 1/1 or less. When the mass ratio (β2/β1) is less than 1/20, improved effects such as crack resistance and stress resistance tend to less appear. When the mass ratio (β2/β1) exceeds 1/1, there is a tendency to take a long time for curing at around room temperature.

(Method of Producing Molded object)

First, for example, a silicon analogue having one or more epoxy groups and an α-hydroxy acid are combined to be compatibilized, and thereby a curable composition is prepared. Subsequently, for example, a molding device is filled with the prepared curable composition. As a result, cation polymerization of the silicon analogue having one or more epoxy groups is performed by using a proton originating from the α-hydroxy acid as an initiator, and a molded object which is a polymer is obtained.

A curing reaction is accompanied by heat and thus, once the reaction starts, the polymerization speeds up. A heat treatment may be carried out as appropriate, for the purpose of shortening the time before the start of the reaction, or for the purpose of increasing the reaction rate higher than a spontaneous reaction.

As the heat treatment, there are, for example, a heat treatment using irradiation of active energy rays such as infrared rays and microwaves, a heat treatment using a heater, an oven, a hot plate, or the like, and one of these heat treatments may be selected as appropriate according to the configuration of a molding device. It is to be noted that a method for the heat treatment is not limited in particular, and may be selected as appropriate according to the purpose of the heat treatment described above. For example, in a case where the purpose is to shorten the time before the start of the reaction, it is possible to employ a method of starting the reaction by irradiating the molding device filled with the curable composition with the microwave and then, stopping the irradiation to leave the curable composition at room temperature, and thereafter allowing the curing with a spontaneous reaction, or a similar method. When the heater, the oven, the hot plate, or the like is used, the reaction is caused to start after the heat treatment is performed for a predetermined time (for example, five minutes), but the upper limit of the temperature of the heat treatment is desirably the boiling point of an ingredient such as the α-hydroxy acid mixed to form the curable composition.

For example, when the molding device is a disk-shaped cell and a heat capacity is small because the injected curable composition is retained thin, an amount of accumulated heat due to a spontaneous reaction also becomes small and therefore, the curing takes a long time. In such a case, it is possible to continue heating as appropriate while adjusting the temperature even after the reaction begins. Usually, it is possible to shorten the curing time by holding the cell at a temperature between the room temperature and 150° C. On the other hand, when the molding device is large-sized and thus the capacity of the injected curable composition is large and a heat capacity is large, there is a case where an amount of accumulated heat due to a spontaneous reaction also becomes large, and the temperature of a reaction system may become too high. In this case, a crack may be caused by a sudden temperature rise, volatilization of the curable composition may be invited, or heat deformation may occur when the molding device is thermoplastic such as being plastic. As a way of avoiding this, it is possible to employ a method of releasing the heat by cooling the molding device after the start of the reaction, and suppressing the reaction rate at the same time.

The curable composition may be filled into the molding device and cured, and used as a sealed molded object as it is, or the molded object may be taken out of the molding device and used. The curable composition according to the present embodiment has such advantages that volatilization and foaming of the solvent do not occur, and a dimensional change is small at the time of curing. Therefore, even when the curable composition is filled into a completely enclosed molding device and cured, excellent integration of the molding device and the molded object may be achieved. In addition, the curable composition according to the present embodiment has high transparency over a near-ultraviolet-ray range, the whole visible-ray range, and a near-infrared-ray range. For this reason, the curable composition may be filled into a transparent molding device similarly transparent and cured, and be in practical use as it is. Of course, after the curable composition is filled into the molding device and cured, the molded object may be taken out of the molding device and used. In this case, the molding device may be coated with a parting agent as necessary so that productivity may be improved. Further, after the curable composition is filled into a die and cured, the cured curable composition may be taken out of the die and used.

### (Effects)

According to the first embodiment, it is possible to prepare the molded object and the polymer, by curing the curable composition including the silicon analogue having the epoxy group and the α-hydroxy acid. Since an organic solvent and a generally-known accelerator are not mixed into the curable composition, a volatile matter is hard to be generated at the time of curing, and the environmental load is small.

The curable composition according to the present embodiment may realize high transparency over the near-ultraviolet-ray range, the whole visible-ray range, and the near-infrared-ray range, and pencil hardness over a wide range of 10 H or more to 10 B, by adjusting the combination as appropriate. Since the curable composition does not contain an accelerator such as amine, it is possible to suppress yellowing of the molded object or the polymer due to ultraviolet rays, and absorption of light in a short wavelength range. In addition, the curable composition has a small volumetric shrinkage factor accompanying the curing and thus, the molded object may be obtained with high dimensional accuracy. Fort this reason, in particular, the curable composition may be suitably applied to a case where the curing is performed with an enclosed molding device and the molding device and the molded object are used as a single piece.

### 2. Second Embodiment

### (Configuration of Optical Information Recording Medium)

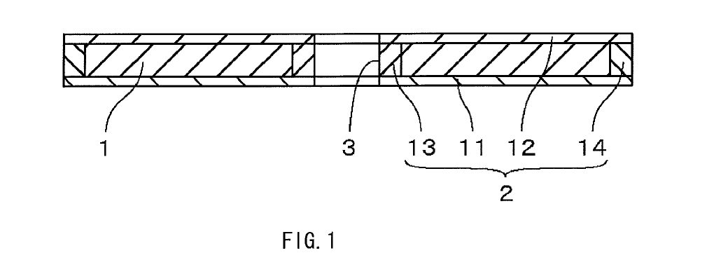

FIG. 1 is a cross-sectional diagram illustrating a configuration of an optical information recording medium according to a second embodiment of the present disclosure. As illustrated in FIG. 1, this optical information recording medium includes a recording layer 1, and a recording-layer molding device 2 inside which this recording layer 1 is molded. The optical information recording medium has, for example, a disk-like shape, and one main surface thereof serves as a signal side that is irradiated with laser beams to record or reproduce information signals. On this signal side, an antireflection layer may be further provided to reduce reflection of the emitted laser beam.

The optical information recording medium, the recording-layer molding device 2, and the recording layer 1 are examples of the sealed molded object, the molding device, and the molded object, respectively, and the shapes of these sealed molded object, molding device, and molded object are not limited to the examples in the present embodiment, and selectable according to desired shapes or characteristics.

The recording layer 1 and the recording-layer molding device 2 of the optical information recording medium will be described below sequentially.

### (Recording Layer)

The recording layer 1 is formed by curing a recording-layer forming composition with polymerization. The recording-layer forming composition contains a curable composition and a foam material dispersed in this curable composition, as main ingredients. As the curable composition, it is possible to use the curable composition according to the above-described first embodiment. As the foam material, it is possible to use, for example, a one-photon absorption material forming by one-photon absorption, or a two-photon absorption material foaming by two-photon absorption. As the two-photon absorption material, it is possible to use, for example, various kinds of organic dye such as cyanine dye, merocyanine dye, arylidene dye, oxonol dye, squalium dye, azo dye, and phthalocyanine dye, or inorganic crystals, or the like, and these materials may be used alone, or two or more kinds of these materials may be mixed and used.

### (Recording-Layer Molding Device)

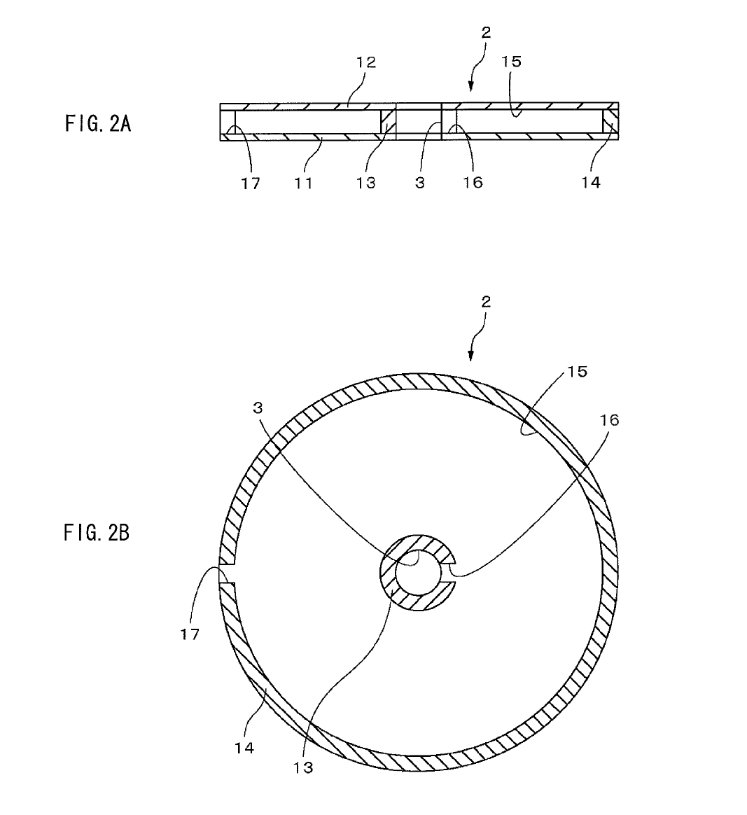

FIG. 2A is a cross-sectional diagram illustrating a configurational example of the recording-layer molding device. FIG. 2B is a plan view illustrating the recording-layer molding device when the recording-layer molding device is viewed from a second substrate. It is to be noted that in FIG. 2B, illustration of a second substrate 12 is omitted so that an internal configuration of the recording-layer molding device 2 is easily understood. As illustrated in FIG. 2A and FIG. 2B, the recording-layer molding device 2 is toric and has a central hole section 3 formed in the center, and a molding space 15 is provided inside thereof to mold the recording layer 1. The recording-layer molding device 2 includes a first substrate 11, the second substrate 12, an inner-circumference-side spacer 13, and an outer-circumference-side spacer 14. The first substrate 11 and the second substrate 12 are disposed to face each other via the inner-circumference-side spacer 13 and the outer-circumference-side spacer 14. The inner-circumference-side spacer 13 is provided at inner circumferential parts of the respective opposed surfaces of the first substrate 11 and the second substrate 12, and the outer-circumference-side spacer 14 is provided at outer circumferential parts of the respective opposed surfaces of the first substrate 11 and the second substrate 12. An injection opening section 16 to inject the recording-layer forming composition is formed on an inner-circumference-side surface of the recording-layer molding device 2. A discharge opening section 17 to discharge an excess of the recording-layer forming composition injected from the injection opening section 16 is formed on an outer-circumference-side surface of the recording-layer molding device 2.

The inner-circumference-side spacer 13 is toric as a whole, and is partially opened to form the injection opening section 16. The outer-circumference-side spacer 14 is toric as a whole, and is partially opened to form the discharge opening section 17. The injection opening section 16 and the discharge opening section 17 may be sealed with a sealing member as necessary.

The first substrate 11 and the second substrate 12 are, for example, shaped like a film, a sheet, or a board. Each of the first substrate 11 and the second substrate 12 has both main surfaces, and the shapes of the both main surfaces are, for example, toric. Materials of the first substrate 11 and the second substrate 12 include, for example, those having a transparent plastic material, glass, or the like as a main component, but are not limited to these materials in particular.

As the glass, for example, soda-lime glass, lead glass, hard glass, quartz glass, liquid crystallization glass, or the like (see “Chemical Handbook” basic edition, P. I-537, by Chemical Society of Japan) is used. As the plastic material, in view of various properties such as optical properties including transparency, refractive index, dispersion, and so on, and further, impact resistance, heat resistance, durability, and the like, it is desirable to use: (meth)acrylic resins such as copolymers of polymethyl methacrylate or methyl methacrylate and vinyl monomer such as other alkyl (meth)acrylate or styrene; polycarbonate resins such as polycarbonate and diethylene glycol-bisallyl carbonate (CR-39); thermosetting (meth)acrylic resins such as homopolymers or copolymers of di(meth)acrylate of (brominated) bisphenol A type, and homopolymers and copolymers of urethane-modified monomer of (brominated) bispenol A mono (meth)acrylate; and polyesters, in particular, polyethylene terephthalates, polyethylene naphthalates, and unsaturated polyesters, acrylonitrile-styrene copolymers, polyvinyl chlorides, polyurethanes, epoxy resins, polyarylates, polyethersulfones, polyether ketones, cycloolefin polymers (trade name: ARTON, ZEONOR), and the like. Further, aramid resin in consideration of heat resistance may also be used.

### (Method of Producing Optical Information Recording Medium)

Next, there will be described an example of a method of producing the optical information recording medium according to the second embodiment of the present disclosure.

First, the foam material is mixed into the curable composition, and therefore the recording-layer forming composition is prepared. Subsequently, the prepared recording-layer forming composition is injected into the molding space 15 from the injection opening section 16 of the recording-layer molding device 2, and an excess of the recording-layer forming composition is discharged from the discharge opening section 17.

Subsequently, the recording-layer forming composition injected into the recording-layer molding device 2 is cured. For the purpose of shortening the time before the start of the reaction or for the purpose of making the reaction rate faster than that of the spontaneous reaction, the recording-layer molding device 2 into which the recording-layer forming composition has been injected may be subjected to a heat treatment. When the recording-layer molding device 2 is made of a plastic material, it is desirable that the temperature of the heat treatment be equal to or lower than the glass transition point, or equal to or lower than the melting point of the plastic material of the recording-layer molding device 2. This is because deformation of the recording-layer molding device 2 may be suppressed. It is to be noted that when two or more kinds of plastic materials are used for a member forming the recording-layer molding device 2, a heat treatment is desired to be performed at a temperature equal to or lower than the lowest glass transition point or equal to or lower than the lowest melting point among those members.

### EXAMPLES

The present disclosure will be described below in detail using examples, but the present disclosure is not limited to these examples.

A siloxane compound A having an epoxy group (hereinafter referred to as an epoxy-siloxane compound as appropriate), and alkoxysilane compounds A to D each having an epoxy group (hereinafter referred to as epoxy-alkoxysilane compounds) were each synthesized as follows.

### (Epoxy-Siloxane Compound A)

First, the following raw materials were prepared.
Alcohol having epoxy group: glycidol
Siloxane oligomer having hydrolysable group: methyl polysilicate (made by COLCOAT Co., Ltd., trade name: MS-53A)
Catalyst of alcohol exchange reaction: dibutyltin dilaurate (IV)

Next, the siloxane oligomer having the hydrolysable group and the glycidol with 1.05 to 1.30 equivalent were weighed in a recovery flask, the catalyst of 0.2 mass % for the total mass was added, and connection to an evaporator was made. The recovery flask was rotated while being soaked in a water bath of 70° C., and was gradually decompressed from atmospheric pressure to 20 mmHg for five hours, and thereby methanol produced by a reaction was distilled. Further, operation was continued with 10 mmHg for about one hour, and stopped when disappearance of the distillation of methanol was confirmed. An epoxy equivalent was measured in accordance with JIS K7236, and the reaction was finished upon confirming an error with respect to a theoretical value fell within 5%. When the measured value of the epoxy equivalent was larger than the theoretical value by 5% or more, the glycidol with 0.1 to 0.3 equivalent was added, and reacted again by the same operation, so that the error fell within 5%.

As a result, the methyl group of the methyl polysilicate was substituted with the epoxy group, and the epoxy siloxane compound A was synthesized.

### (Epoxy-Alkoxysilane Compound A)

The following raw materials were used, and otherwise, the epoxy-alkoxysilane compound A was synthesized in a manner similar to the epoxy-siloxane compound A. As a result, the hydrolysable group of the phenyltriethoxysilane was substituted with the epoxy group, and the epoxy-alkoxysilane compound A was synthesized.
Alcohol having epoxy group: glycidol
Alkoxysilane compound having hydrolysable group: phenyltriethoxysilane
Catalyst of alcohol exchange reaction: dibutyltin dilaurate (IV)

### (Epoxy-Alkoxysilane Compound B)

Dimethoxydiphenylsilane was used as the alkoxysilane compound having the hydrolysable group, and otherwise, the epoxy-alkoxysilane compound B was synthesized in a manner similar to the epoxy-alkoxysilane compound A. As a result, the hydrolysable group of the dimethoxydiphenylsilane was substituted with the epoxy group, and the epoxy-alkoxysilane compound B was synthesized.

### (Epoxy-Alkoxysilane Compound C)

Cyclohexyltrimethoxysilane was used as the alkoxysilane compound having the hydrolysable group, and otherwise, the epoxy-alkoxysilane compound C was synthesized in a manner similar to the epoxy-alkoxysilane compound A. As a result, the hydrolysable group of the cyclohexyltrimethoxysilane was substituted with the epoxy group, and the epoxy-alkoxysilane compound C was synthesized.

### (Epoxy-Alkoxysilane Compound D)

Hexyltrimethoxysilane was used as the alkoxysilane compound having the hydrolysable group, and otherwise, the epoxy-alkoxysilane compound D was synthesized in a manner similar to the epoxy-alkoxysilane compound A. As a result, the hydrolysable group of the hexyltrimethoxysilane was substituted with the epoxy group, and the epoxy-alkoxysilane compound D was synthesized.

Next, a thermosetting composition was prepared using the epoxysiloxane compound A and the epoxy-alkoxysilane compounds A to D synthesized as described above.

### Examples 1-1 to 1-5

The epoxy-siloxane compound A as a siloxane derivative and a DL-lactic acid as a carboxylic acid were combined to be compatibilized in a mass ratio of 10:1 to 60:1 as shown in Table 2, and therefore a thermosetting composition was prepared.

### Example 2-1 to 2-5

As shown in Table 2, a thermosetting composition was prepared in a similar manner to the example 1, except that a DL-2-hydroxybutyric acid was used as the carboxylic acid.

### Example 3-1 to 3-5

The epoxy-siloxane compound A as a siloxane derivative, the epoxy-alkoxysilane compound A as an alkoxysilane derivative, and a DL-lactic acid as a carboxylic acid were combined to be compatibilized in a mass ratio of 7:3:1 to 28:12:1 as shown in Table 2, and therefore a thermosetting composition was prepared.

### Examples 4-1 to 4-5

The epoxy-siloxane compound A as a siloxane derivative, the epoxy-alkoxysilane compound B as an alkoxysilane derivative, and a DL-lactic acid as a carboxylic acid were combined to be compatibilized in a mass ratio of 7:3:1 to 28:12:1 as shown in Table 2, and therefore a thermosetting composition was prepared.

### Examples 5-1 to 5-5

The epoxy-siloxane compound A as a siloxane derivative, the epoxy-alkoxysilane compound C as an alkoxysilane derivative, and a DL-lactic acid as a carboxylic acid were combined to be compatibilized in a mass ratio of 7:3:1 to 28:12:1 as shown in Table 2, and therefore a thermosetting composition was prepared.

### Examples 6-1 to 6-5

The epoxy-siloxane compound A as a siloxane derivative, the epoxy-alkoxysilane compound D as an alkoxysilane derivative, and a DL-lactic acid as a carboxylic acid were combined to be compatibilized in a mass ratio of 7:3:1 to 28:12:1 as shown in Table 2, and therefore a thermosetting composition was prepared.

### Example 7

The epoxy-alkoxysilane compound A as an alkoxysilane compound derivative, and a DL-lactic acid as a carboxylic acid were combined to be compatibilized in a mass ratio of 10:1 as shown in Table 2, and therefore a thermosetting composition was prepared.

### Example 8

The epoxy-alkoxysilane compound B as an alkoxysilane compound derivative, and a DL-lactic acid as a carboxylic acid were combined to be compatibilized in a mass ratio of 10:1 as shown in Table 2, and therefore a thermosetting composition was prepared.

### Example 9

The epoxy-alkoxysilane compound C as an alkoxysilane compound derivative, and a DL-lactic acid as a carboxylic acid were combined to be compatibilized in a mass ratio of 10:1 as shown in Table 2, and therefore a thermosetting composition was prepared.

### Example 10

The epoxy-alkoxysilane compound D as an alkoxysilane compound derivative, and a DL-lactic acid as a carboxylic acid were combined to be compatibilized in a mass ratio of 10:1 as shown in Table 2, and therefore a thermosetting composition was prepared.

### Comparative Example 1

The epoxy-siloxane compound A as a siloxane compound derivative, and an acetic acid as a carboxylic acid were combined to be compatibilized in a mass ratio of 10:1 as shown in Table 2, and therefore a thermosetting composition was prepared.

### Comparative Example 2

The epoxy-siloxane compound A as a siloxane compound derivative, and a DL-3-hydroxybutyric acid as a carboxylic acid were combined to be compatibilized in a mass ratio of 10:1 as shown in Table 2, and thereby a thermosetting composition was prepared.

For the thermosetting compositions of the examples 1-1 to 6-5 and 7 to 10, as well as the comparative examples 1 and 2 obtained as described above, the following characterizations (1) to (5) were performed.

### (1) Property and Hardness

First, aligning the size with an edge part of a slide glass of 40 mm×40 mm×0.7 mm, a silicone spacer having a central part being punched in a square and having a width of 5 mm and a thickness of 0.3 mm was mounted on the slide glass. Subsequently, the thermosetting composition was dropped on the slide glass, was overlaid with a cover glass having the same size as that of the slide glass and subjected to a surface-release treatment, and then was clamped to be an evaluation sample. As for a curing method, in the examples 1 to 10, the evaluation sample was placed on a hot plate and heated at 90° C. for five minutes. Subsequently, the evaluation sample was cooled to room temperature, the cover glass was removed, and the properties of a cured object were observed. Furthermore, after the evaluation sample was left at room temperature for twelve hours, “scratch hardness” of the cured thermosetting composition was measured (in accordance with a pencil method, JIS K5600), which was made as final hardness. In the comparative examples 1 and 2, the evaluation sample was placed on the hot plate and heated at 100° C. for 60 minutes. Subsequently, the evaluation sample was cooled to room temperature, the cover glass was removed and further, the evaluation sample was left at room temperature for 48 hours, and “scratch hardness” (in accordance a pencil method, JIS K5600) of the cured thermosetting composition was measured, which was made as final hardness.

### (2) Curing Shrinkage

First, an injector was connected to one end of a Teflon tube (inside diameter of 3 mm, external form of 4 mm) having an inner surface made smooth, and the thermosetting composition was sucked from the other end. Subsequently, when the length of the sucked thermosetting composition reached 500 mm, air was sucked approximately 10 mm, and the thermosetting composition was moved to the deep recesses of the tube. Next, after a suction port was blocked with a Teflon cap and the injector was removed, the thermosetting composition was heated at 90° C. for five minutes and cured. Subsequently, marks were made on the tube at both ends of the cured object, and the length between the both ends was determined. Then, this was put in an oven heated at 100° C., and heated for one hour. Based on a change in the length of the resin before and after the curing, a volumetric shrinkage factor by heat was determined

### (3) Light Transmittance

First, two quartz glass plates each having a thickness 0 7 mm were prepared, and the thermosetting composition was clamped between them. Otherwise, an evaluation cell was produced in a manner similar to the case of (1) hardness measurement. Subsequently, a light transmittance in a wavelength range 400 to 800 nm was measured using ARM-500V of JASCO Corporation. Measurement conditions were an incidence angle of light to a surface of the evaluation sample: 90 degrees, and light sources: a tungsten lamp (visible-light range), a deuterium lamp (UV range), and N-polarized light.

### (4) Change in Light Transmittance (Weathering Test)

The same sample made by the evaluation in the above-described (3) was irradiated with light of 90,000 kJ/m² by a weather meter (a light source: a xenon lamp) and then, the light transmittance was measured with a spectrophotometer. Subsequently, based on the measurement data, a change in light transmittance for each wavelength was obtained from the following expression.

(Change in light transmittance)[%]=[(transmittance before weathering test)−(transmittance after weathering test)]/(transmittance before weathering test)×100

### (5) Crack Initiation (Weathering Test)

With the sample after the weathering test, the presence or absence of crack initiation of the cured object was observed.

Table 1 shows the ingredients of the epoxy-siloxane compound A, and the epoxy-alkoxysilane compounds A to D.

TABLE 1

| | | Ingredients | | |
|---|---|---|---|---|
| | | Siloxane | | Alcohol having |
| | | compound | Alkoxysilane compound | epoxy group |
| Derivative | Epoxy-siloxane | Methyl | — | Glycidol |
| | compound A | polysilicate | | |
| | (siloxane derivative) | (MS-53A) | | |
| | Epoxy-alkoxysilane | — | Phenyltriethoxysilane | Glycidol |
| | compound A | | | |
| | (alkoxysilane derivative) | | | |
| | Epoxy-alkoxysilane | — | Dimethoxydiphenylsilane | Glycidol |
| | compound B | | | |
| | (alkoxysilane derivative) | | | |
| | Epoxy-alkoxysilane | — | Cyclohexyltrimethoxysilane | Glycidol |
| | compound C | | | |
| | (alkoxysilane derivative) | | | |
| | Epoxy-alkoxysilane | — | Hexyltrimethoxysilane | Glycidol |
| | compound D | | | |
| | (alkoxysilane derivative) | | | |

Table 2 shows the compositions and evaluation results of the thermosetting compositions of the examples 1-1 to 6-5 and 7 to 10, and the comparative examples 1 and 2.

TABLE 2

| | | | | | | | Weathering test | |
|---|---|---|---|---|---|---|---|---|
| | | | | | | | Change in | |
| | | Compounding | | | Curing | Light | light | Crack |
| | Ingredients | ratio | Property | Hardness | shrinkage | transmittance | transmittance | initiation |
| Example 1-1 | Epoxy-siloxane compound A: | 10:1 | Vitreous | 8H | <1% | >99% | <1% | Present |
| Example 1-2 | DL-lactic acid | 20:1 | Elastic | 3H | — | — | — | — |
| Example 1-3 | | 40:1 | gel | 7B | — | — | — | — |
| Example 1-4 | | 50:1 | | >10B | — | — | — | — |
| Example 1-5 | | 60:1 | | >10B | — | — | — | — |
| Example 2-1 | Epoxy-siloxane compound A: | 10:1 | Elastic | HB | <1% | >99% | <1% | Present |
| Example 2-2 | DL-2-hydroxybutyric acid | 20:1 | gel | >10B | — | — | — | — |
| Example 2-3 | | 40:1 | Liquid | — | — | — | — | — |
| Example 2-4 | | 50:1 | | — | — | — | — | — |
| Example 2-5 | | 60:1 | | — | — | — | — | — |
| Example 3-1 | Epoxy-siloxane compound A: | 7:3:1 | Elastic | ≧10H | — | — | — | — |
| Example 3-2 | Epoxy-alkoxysilane | 5:5:1 | gel | ≧10H | — | — | — | — |
| Example 3-3 | compound A: | 13:7:1 | | 9H | — | — | — | — |
| Example 3-4 | DL-lactic acid | 10:10:1 | | 10B | — | — | — | — |
| Example 3-5 | | 28:12:1 | | 6B | <1% | >99% | <1% | Absent |
| Example 4-1 | Epoxy-siloxane compound A: | 7:3:1 | Elastic | ≧10H | — | — | — | — |
| Example 4-2 | Epoxy-alkoxysilane | 5:5:1 | gel | 3H | — | — | — | — |
| Example 4-3 | compound B: | 13:7:1 | | 8H | — | — | — | — |
| Example 4-4 | DL-lactic acid | 10:10:1 | | 9B | — | — | — | — |
| Example 4-5 | | 28:12:1 | | 10B | <1% | >99% | <1% | Absent |
| Example 5-1 | Epoxy-siloxane compound A: | 7:3:1 | Elastic | ≧10H | — | — | — | — |
| Example 5-2 | Epoxy-alkoxysilane | 5:5:1 | gel | 3H | — | — | — | — |
| Example 5-3 | compound C: | 13:7:1 | | 8H | — | — | — | — |
| Example 5-4 | DL-lactic acid | 10:10:1 | | 10B | — | — | — | — |
| Example 5-5 | | 28:12:1 | | 9B | <1% | >99% | <1% | Absent |
| Example 6-1 | Epoxy-siloxane compound A: | 7:3:1 | Elastic | ≧10H | — | — | — | — |
| Example 6-2 | Epoxy-alkoxysilane | 5:5:1 | gel | F | — | — | — | — |
| Example 6-3 | compound D: | 13:7:1 | | 9H | — | — | — | — |
| Example 6-4 | DL-lactic acid | 10:10:1 | | 10B | — | — | — | — |
| Example 6-5 | | 28:12:1 | | 10B | <1% | >99% | <1% | Absent |
| Example 7 | Epoxy-alkoxysilane | 10:1 | Elastic | <10B | <1% | >99% | <1% | Absent |
| | compound A:DL-lactic acid | | gel | | | | | |
| Example 8 | Epoxy-alkoxysilane | 10:1 | | <10B | <1% | >99% | <1% | Absent |
| | compound B:DL-lactic acid | | | | | | | |
| Example 9 | Epoxy-alkoxysilane | 10:1 | | <10B | <1% | >99% | <1% | Absent |
| | compound C:DL-lactic acid | | | | | | | |
| Example 10 | Epoxy-alkoxysilane | 10:1 | | <10B | <1% | >99% | <1% | Absent |
| | compound D:DL-lactic acid | | | | | | | |
| Comparative | Epoxy-siloxane compound A: | 10:1 | Elastic | 4B | — | — | — | — |
| example 1 | acetic acid | | gel | | | | | |
| Comparative | Epoxy-siloxane compound A: | 10:1 | | 4B | — | — | — | — |
| example 2 | DL-3-hydroxybutyric acid | | | | | | | |

The followings have been found from the above-described evaluation results. When the carboxylic acid did not have a hydroxy group like the comparative examples 1 and 2, or when the carboxylic acid had a hydroxy group which was however a β-hydroxy acid, the curing took a long time, and the obtained hardness was low. In contrast, when the carboxylic acid was an α-hydroxy acid as in the examples 1-1 to 1-5, 2-1 to 2-2, 3-1 to 6-5, and the examples 7 to 10, the property of vitreousness or elastic gel (no surface tucking) was obtained by heating at 90° C. for 5 minutes. Further, by the progress of the reaction at room temperature for 12 hours, the hardness in a wide range of pencil hardness 10H to 10B was obtained according to the composition of the thermosetting composition. By using this property, it is possible to realize a production method of obtaining a complete cured object by, for example, performing short-time heating on a manufacturing process and thereby obtaining the hardness in a level of giving no hindrance to the next process and implementing the remaining processes, and thereafter, allowing the curing to proceed at room temperature for a set period of time including the time for these processes.

It is to be noted that the reason that there are thermosetting compositions having lower hardness among the examples 1-1 to 6-5, and 7 to 10 than those of the thermosetting compositions of the comparative examples 1 and 2 in Table 2 is because the curing conditions are different as described above in “(1) Property and Hardness”. When the thermosetting compositions of the examples 1-1 to 6-5, and 7 to 10 and the comparative examples 1 and 2 are cured under the same curing conditions, hardness of the thermosetting compositions of the examples 1-1 to 6-5, and 7-10 higher than those of the comparative examples 1 and 2 is obtained.

In addition, when the thermosetting compositions of the examples 2-3 to 2-5 in which the evaluation results of the properties are “liquid” are similarly cured under the same curing conditions, there is obtained hardness higher than those of the thermosetting compositions in the comparative examples 1 and 2.

By the combination of the example 1-1, the vitreous cured objected was obtained. By the combinations of all the remaining examples 1-2 to 1-5, 2-1 to 2-2, 3-1 to 6-5, and 7 to 10, non-vitreous elastic gel was obtained. In addition, elastic gel of low hardness was obtained for the examples 2-1 and 2-2 among the examples 2-1 to 2-5. From this, it is found that among the α-hydroxy acids, the DL-lactic acid shows remarkably high curing facilitation.

Among the examples 1-1, 2-1, 3-5, 4-5, 6-5, and 7 to 10, which underwent the weathering test, the examples 1-1 and 2-1 including no epoxyalkoxysilane compound had cracks. From this, it is found that mixing the epoxy-alkoxysilane compound produces a high effect of suppressing cracks.

When focusing on the evaluation results of the examples 3-1 to 3-4, 4-1 to 4-4, 5-1 to 5-4, and 6-1 to 6-4, it is found that it is possible to control the hardness of the cured object over a wide range by changing the mixture ratio of the siloxane derivative and the alkoxysilane derivative, when the ratio between the total mass of the siloxane derivative and the alkoxysilane derivative and the mass of the carboxylic acid is fixed to 10/1 and 20/1. This is an effect produced by introducing a segment in which hardness of a cured object is low as represented by the examples 7 to 10. In addition, it is conceivable that the reason the hardness of the examples 3-1, 4-1, 5-1, and 6-1 have been measured as higher than that of the example 1-1 may be because by introducing these segments, the surface has become hard to damage and at the same time, the restoring force against indentation has increased and thus, the hardness has been evaluated as high for pencil hardness.

In the weathering test, for any of the samples of the examples 1-1, 2-1, 3-5, 4-5, 5-5, 6-5, and 7 to 10, no decline of the light transmittance, namely, no color change such as yellowing was found.

In the thermosetting compositions of the examples 1-1, 2-1, 3-5, 4-5, 5-5, 6-5, and 7 to 10, the epoxy group is provided as a linking group and thus, the curing shrinkage is less than 1%.

The shrinkage factor of an acrylic material (ultraviolet curing resin) is around 7 to 10% and thus, it is possible for the thermosetting compositions of the examples 1-1, 2-1, 3-5, 4-5, 5-5, 6-5, and 7 to 10 to achieve the shrinkage factor lower than those of acrylic materials. Therefore, even when they are filled into an enclosed molding device and cured, it is hard to cause damage or deformation of the molding device due to a volumetric change, or separation of the molded object from the molding device.

Up to this point, the embodiments of the present technology have been described specifically, but the present technology is not limited to the above-described embodiments and may be variously modified based on technical ideas of the present technology.

For example, the configurations, methods, processes, shapes, materials, numerical values, and the like described above for the embodiments are merely examples, and other configurations, methods, processes, shapes, materials, numerical values, and the like different from those described above may be used as necessary.

Further, it is possible to combine the configurations, methods, processes, shapes, materials, numerical values, and the like of the embodiments with one another, without departing from the purport of the present disclosure.

The present disclosure contains subject matter related to that disclosed in Japanese Priority Patent Application JP 2010-258081 filed in the Japan Patent Office on Nov. 18, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof

What is claimed is:

1. A molded object obtained by curing a curable composition containing a silicon analogue having one or more epoxy groups and an α-hydroxy acid.

2. The molded object according to claim 1, wherein the silicon analogue contains one or more kinds of a siloxane compound and an alkoxysilane compound.

3. The molded object according to claim 2, wherein the silicon analogue contains a siloxane compound and an alkoxysilane compound.

4. The molded object according to claim 2, wherein the siloxane compound is expressed by a general formula (1) as follows, and the alkoxysilane compound is expressed by a general formula (2) as follows. 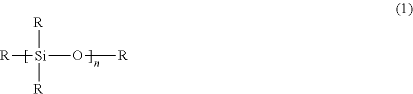
(where, in the formula (1), R represents an alkyl group, an aryl group, an alkyloxy group, an aryloxy group, and an ether group having one or more epoxy groups as a substructure, which may have a substituent and may be different from each other, and one or more of them is an ether group having one or more epoxy groups. n represents an integer of 1 or more.) 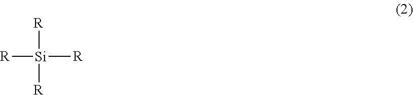
(where, in the formula (2), R represents an alkyl group, an aryl group, an alkyloxy group, an aryloxy group, and an ether group having one or more epoxy groups as a substructure, which may have a substituent and may be different from each other, and one or more of them is an ether group having one or more epoxy groups. n represents an integer of 1 or more.)

5. The molded object according to claim 1, wherein the cured curable composition contains a polymer obtained by performing ring-opening polymerization of the epoxy group of the silicon analogue, as a main component.

6. The molded object according to claim 1, wherein the curable composition is a thermosetting composition that is cured by a thermal reaction.

7. The molded object according to claim 1, wherein the cured curable composition has transparency for light within a wavelength range of 400 nm or more to 800 nm or less, and a difference ΔTr (=Trₘₐₓ−Trₘᵢₙ) between a maximum value Trₘₐₓ and a minimum value Trₘᵢₙ of light transmittance within the wavelength range is 3% or less.

8. The molded object according to claim 1, wherein the cured molded object is vitreous or an elastic gel.

9. The molded object according to claim 1, wherein a melting point of the α-hydroxy acid is 100° C. or below.

10. The molded object according to claim 1, wherein the α-hydroxy acid is one or more kinds of a lactic acid, a glycolic acid, and a 2-hydroxybutyric acid.

11. A sealed molded object comprising:
a molding device having a molding space inside; and
a molded object molded in the molding space,
wherein the molded object is obtained by curing a curable composition containing a silicon analogue having one or more epoxy groups and an α-hydroxy acid.

12. A method of producing a molded object, the method comprising:
preparing a curable composition containing a silicon analogue having one or more epoxy groups and an α-hydroxy acid; and
forming a molded object by curing the curable composition.

13. The method according to claim 12, further comprising, prior to preparing the curable composition:
synthesizing the silicon analogue having one or more epoxy groups, by continuously depressurizing a siloxane compound having a siloxane skeleton and having a hydrolysable group as a side chain and/or an end group of the skeleton, and/or an alkoxysilane compound having a hydrolysable group, and an alcohol or a thiol having one or more epoxy groups, in an environment at a temperature of 80° C. or below, by using an evaporator.

14. The method according to claim 12, wherein in forming the molded object, the molded object is formed by supplying the curable composition to an enclosed molding device and curing the curable composition.

15. The method according to claim 12, wherein in forming the molded object, the molded object is formed by supplying the curable composition to a die and curing the curable composition.

16. A polymer obtained by polymerizing a silicon analogue having one or more epoxy groups, by using a proton originating from an α-hydroxy acid as an initiator.

17. An optical information recording medium comprising:
a recording layer; and
a recording-layer molding device inside which the recording layer is molded,
wherein the recording layer is obtained by curing a recording-layer forming composition, and
the recording-layer forming composition contains a silicon analogue having one or more epoxy groups, an α-hydroxy acid, and a foam material.

18. The optical information recording medium according to claim 17, wherein the recording layer foams by absorption of light condensed when recording an information signal, and is capable of forming a cavity as a record mark.
